(19) United States
(12) Patent Application Publication
(10) Pub. No.: US 2018/0170294 A1
(43) Pub. Date: Jun. 21, 2018

(54) ENERGY ABSORPTION STRUCTURE

(71) Applicant: TOYOTA JIDOSHA KABUSHIKI KAISHA, Toyota-shi (JP)

(72) Inventors: Hiroki HASHIMOTO, Nisshin-shi (JP); Shintaro KITAKATA, Nisshin-shi (JP)

(73) Assignee: TOYOTA JIDOSHA KABUSHIKI KAISHA, Toyota-shi (JP)

(21) Appl. No.: 15/834,502

(22) Filed: Dec. 7, 2017

(30) Foreign Application Priority Data
Dec. 21, 2016 (JP) 2016-248304

(51) Int. Cl. B60R 19/34; B60R 19/02

(52) U.S. Cl. CPC B60R 19/34; B60R 2019/247; B60R 19/023

(57) ABSTRACT

An energy absorption structure includes a bumper RF and a crush box. The crush box includes a main body part and a coupling part. The coupling part includes an inner fastening part that is fastened to a bumper RF by an inner fastener, and an outer fastening part that is fastened to the bumper RF by an outer fastener at a position behind a position where the inner fastening part is fastened to the bumper RF outward from the center in a vehicle width direction of a vehicle. The outer fastening part includes a weakened part having a structure different from the inner fastening part such that the outer fastening part is easily crushed as compared to the inner fastening part when a load toward a side far from the center in the forward-rearward direction of the vehicle acts on the outer fastener.

### INCORPORATION BY REFERENCE

The disclosure of Japanese Patent Application No. 2016-248304 filed on Dec. 21, 2016 including the specification, drawings and abstract is incorporated herein by reference in its entirety.

### BACKGROUND

### 1. Technical Field

The present disclosure relates to an energy absorption structure.

### 2. Description of Related Art

Japanese Unexamined Patent Application Publication No. 2015-182595 (JP 2015-182595 A) discloses an energy absorption structure including a crush box made of carbon fiber reinforced resin (made of CFRP). In the energy absorption structure, a front flange of a crush box is fastened to a bumper reinforcement (hereinafter may be abbreviated as a bumper RF) with fasteners, such as bolts and nuts.

### SUMMARY

In a vehicle including the above energy absorption structure, during an offset collision, a collision-side portion of the bumper RF is displaced to the rear of the vehicle, while a portion opposite to the collision-side portion of the bumper RF is tilted in a plan view of the vehicle. Then, a load is applied to the front flange of the crush box fastened to the portion opposite to the collision-side portion via the fasteners, such as bolts and nuts, and a bending moment acts on the overall crush box.

Here, in the above energy absorption structure, since the crush box is made of fiber reinforced resin, there is a possibility that the crush box may break without withstanding the bending moment. When the crush box breaks, transmission of a load to a front side member connected to a rear side of the crush box is no longer performed. As a result, there is a possibility that desired energy absorption performance is no longer obtained.

The present disclosure provides an energy absorption structure that can further suppress breaking of a crush box on a side opposite to the collision side due to a bending moment during an offset collision.

An aspect of the present disclosure relates to an energy absorption structure including a bumper reinforcement that is provided at a front end part or a rear end part of a vehicle and extends in a vehicle width direction of the vehicle; and a crush box that is coupled to the bumper reinforcement and is made of fiber reinforced resin. The crush box is coupled to the bumper reinforcement at a position shifted outward in the vehicle width direction with respect to the center in the vehicle width direction of the vehicle. The crush box includes a main body part and a coupling part, the main body part is a portion that is disposed at a position closer to the center in a forward-rearward direction of the vehicle than the bumper reinforcement in the forward-rearward direction of the vehicle, and the coupling part is a portion that couples the crush box and the bumper reinforcement together. The coupling part includes an inner fastening part and an outer fastening part, the inner fastening part is fastened to the bumper reinforcement by an inner fastener, and the outer fastening part is fastened to the bumper reinforcement by an outer fastener at a position behind a position where the inner fastening part is fastened to the bumper reinforcement outward from the center in the vehicle width direction of the vehicle. The outer fastening part includes a weakened part having a structure different from the inner fastening part such that the outer fastening part is easily crushed as compared to the inner fastening part when a load toward a side far from the center in the forward-rearward direction of the vehicle acts on the outer fastener.

In addition, the expression “a position closer to the center in a forward-rearward direction of the vehicle” herein means a rearward side of the vehicle in a case where the bumper RF is provided at the front end part of the vehicle, and means a front side of the vehicle in a case where the bumper RF is provided at a rear end part of the vehicle. Additionally, the expression “a side far from the center in the forward-rearward direction of the vehicle” of “a load toward a side far from the center in the forward-rearward direction of the vehicle” means the front side of the vehicle in a case where the bumper RF is provided at the front end part of the vehicle, and means the rearward side of the vehicle in a case where the bumper RF is provided at the rear end part of the vehicle.

According to the aspect of the present disclosure, the crush box made of the fiber reinforced resin is coupled to the bumper RF that is provided at the front end part or the rear end part of the vehicle and extends in the vehicle width direction of the vehicle. A position where the crush box is coupled is a position shifted outward in the vehicle width direction with respect to the center in the vehicle width direction of the vehicle. The crush box is configured to include the main body part disposed at the position closer to the center in the forward-rearward direction of the vehicle, and the coupling part for coupling the crush box and the bumper RF together. Also, the coupling part is configured to include the inner fastening part and the outer fastening part that are fastened to the bumper RF. The outer fastening part is fastened to the bumper RF at the position behind the position where the inner fastening part is fastened to the bumper RF outward from the center in the vehicle width direction of the vehicle.

For this reason, for example, in a vehicle in which the energy absorption structure of the aspect of the present disclosure is applied to a vehicle front structure, during an offset collision, a collision-side portion of the bumper RF is displaced to the rear of the vehicle, while a portion opposite to the collision-side portion of the bumper RF tries to be tilted in a plan view of the vehicle. Then, a load to the rear side of the vehicle (position near the center in the forward-rearward direction of a vehicle) is applied to the inner fastener, which fastens the inner fastening part, in the coupling part of the crush box fastened to the portion opposite to the collision-side portion, and a load to the front side of the vehicle (the side far from the center in the forward-rearward direction of the vehicle) is applied to the outer fastener that fastens the outer fastening part.

According to the aspect of the present disclosure, the outer fastening part is provided with the weakened part having a structure different to the inner fastening part. Since the weakened part has the structure different from the inner fastening part, the outer fastening part is easily crushed as compared to the inner fastening part when the load toward the side far from the center in the forward-rearward direction of the vehicle acts on the outer fastener. That is, as compared to a case where the portion of the outer fastening part, which is provided with the weakened part, has the same structure (for example, plate thickness, the orientation ratio of fiber, or the like) as the inner fastening part, according to the aspect of the present disclosure, the weakened part provided at the outer fastening part is easily crushed as compared to the inner fastening part when the load toward the side far from the center in the forward-rearward direction of the vehicle acts on the outer fastener. When the weakened part of the outer fastening part is crushed, the bending moment acting on the main body part of the crush box is further suppressed, and breaking of the main body part of the crush box due to the bending moment is further suppressed. As a result, a load is more easily transmitted to a member (for example, a front side member) on the rear side (the position closer to the center in the forward-rearward direction of the vehicle) of the vehicle of the crush box via the crush box.

In the energy absorption structure according to the aspect of the present disclosure, the inner fastener may include a shaft part that passes through the inner fastening part and has an axial direction directed to an upward-downward direction of the vehicle.

In addition, in the present specification, the expression “the upward-downward direction of the vehicle” includes meaning “a substantially upward-downward direction of the vehicle”. Here, the “substantially” of “a substantially upward-downward direction of the vehicle” is the meaning including that the shaft part is tilted to a range of 5 degrees or less with respect to a vertical direction (the upward-downward direction of the vehicle).

According to the aspect of the present disclosure, the inner fastener is configured to include the shaft part that passes through the inner fastening part, and the shaft part has the axial direction directed to the substantially upward-downward direction of the vehicle. For this reason, the bumper RF can rotate about the shaft part of the inner fastener with respect to the crush box, and even when the portion opposite to the collision-side portion of the bumper RF is tilted in a plan view of the vehicle during an offset collision, the fastening performed by the inner fastener is more easily maintained. As a result, a load from the bumper RF is more easily transmitted to a member at a position closer to the center in the forward-rearward direction of the vehicle of the crush box via the crush box.

In the energy absorption structure according to the aspect of the present disclosure, the weakened part may be a portion that is formed to be thinner than the inner fastening part.

According to the aspect of the present disclosure, the weakened part is provided by being formed to be thinner than the inner fastening part.

In the energy absorption structure according to the aspect of the present disclosure, the weakened part may be a portion having a fiber orientation ratio different from the inner fastening part.

According to the aspect of the present disclosure, the weakened part is provided by having a fiber orientation ratio different from the inner fastening part.

As described above, the aspect of the present disclosure can further suppress breaking of the crush box on the side opposite to the collision side due to the bending moment during an offset collision.

### BRIEF DESCRIPTION OF THE DRAWINGS

Features and advantages, and technical and industrial significance of exemplary embodiments of the present disclosure will be described below with reference to the accompanying drawings, in which like numerals denote like elements, and wherein:

FIG. 1 is an enlarged perspective view illustrating a front coupling part of a crush box provided on a left side in a vehicle width direction in an energy absorption structure of an embodiment;

FIG. 2A is an enlarged cut end view (a cut end view taken along line IIA-IIA of FIG. 1) illustrating a peripheral portion (outer fastening part) of an outer fastening hole of the embodiment;

FIG. 2B is an enlarged sectional view (a sectional view taken along line IIB-IIB of FIG. 1) illustrating the peripheral portion (outer fastening part) of the outer fastening hole of the embodiment from a different direction;

FIG. 3A is an enlarged cut end view (a cut end view taken along line IIIA-IIIA of FIG. 1) illustrating a peripheral portion (inner fastening part) of an inner fastening hole of the embodiment;

FIG. 3B is an enlarged sectional view (a sectional view taken along line IIIB-IIIB of FIG. 1) illustrating the peripheral portion (inner fastening part) of the inner fastening hole of the embodiment from a different direction;

FIG. 4 is a perspective view illustrating an overall configuration of the energy absorption structure of the embodiment;

FIG. 5A is a schematic plan view illustrating a state immediately before an offset collision occurs in a vehicle including the energy absorption structure of the embodiment;

FIG. 5B is a schematic plan view illustrating a state immediately after the offset collision occurs;

FIG. 6 is an enlarged perspective view illustrating a front joining part of a crush box of Modification Example 1;

FIG. 7 is an enlarged perspective view illustrating a front joining part of a crush box of Modification Example 2; and

FIG. 8 is a sectional view (a sectional view taken along line VIII-VIII of FIG. 7) illustrating the energy absorption structure of Modification Example 2.

### DETAILED DESCRIPTION OF EMBODIMENTS

Hereinafter, a vehicle body front structure 10 to which an energy absorption structure S related to an embodiment of the present disclosure is applied will be described with reference to the drawings. In addition, as appropriately illustrated in the respective drawings, arrow FR indicates the front of a vehicle, arrow UP indicates the upside of the vehicle, arrow LH indicates the left side in a vehicle width direction, and arrow OUT indicates the outside in the vehicle width direction. Additionally, in the following description, in a case where description is made using a forward-rearward direction, an upward-downward direction, and a rightward-leftward direction unless otherwise noted, these directions respectively indicate front and rear in a vehicle forward-rearward direction, up and down in a vehicle upward-downward direction, and right and left in a vehicle width direction.

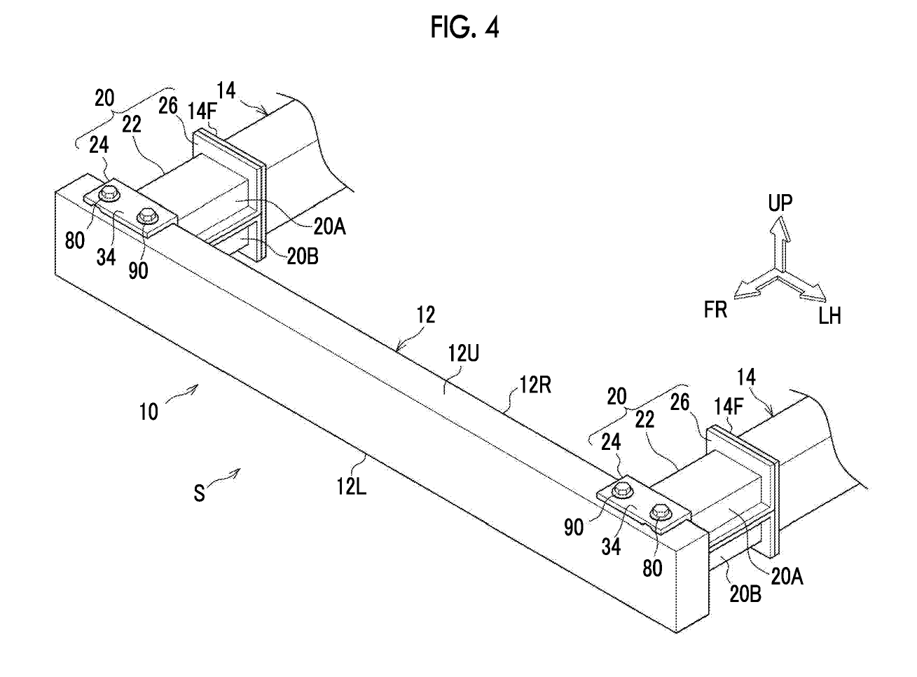

FIG. 4 is a perspective view illustrating a schematic configuration of the vehicle body front structure 10. As illustrated in FIG. 4, the vehicle body front structure 10 is configured to include a front bumper reinforcement 12 (hereinafter abbreviated as a “bumper RF 12”) serving as a “bumper reinforcement”, a crush box 20 coupled to the bumper RF 12, and a front side member 14 connected to a rear side of the crush box 20.

The bumper RF 12 is a skeleton member that is provided at a front end part of the vehicle and extends in the vehicle width direction. A front bumper cover (not illustrated) that forms a design surface of the vehicle is disposed via an absorber (not illustrated) or the like in front of the bumper RF 12. Although the bumper RF 12 is formed of a steel material in the present embodiment, the bumper RF 12 may be formed of a nonferrous metal material or may be formed of fiber reinforced resin, such as carbon fiber reinforced resin. Additionally, for simplification in the respective drawings including FIG. 4, the bumper RF 12 that linearly extends in the vehicle width direction is illustrated. However, the bumper RF 12 may be formed, for example, in an arcuate shape that is convex to the front of the vehicle.

The front side member 14 is a skeleton member that is provided behind the bumper RF 12 at a front part of the vehicle and extends in the forward-rearward direction of the vehicle. A pair of right and left front side members 14 is provided and is disposed side by side symmetrically with respect to the center in the vehicle width direction. The front side members 14 are formed of a steel material, as an example.

A pair of the right and left crush boxes 20 is provided, the right crush box 20 is disposed between a front end of the right front side member 14 and the bumper RF 12, and the left crush box 20 is disposed between a front end of the left front side member 14 and the bumper RF 12. The left crush box 20 is coupled to the bumper RF 12 at a position shifted to the left side in the vehicle width direction with respect to the center in the vehicle width direction, and the right crush box 20 is coupled to the bumper RF 12 at a position shifted to the right side in the vehicle width direction with respect to the center in the vehicle width direction. The crush boxes 20 are made of the carbon fiber reinforced resin.

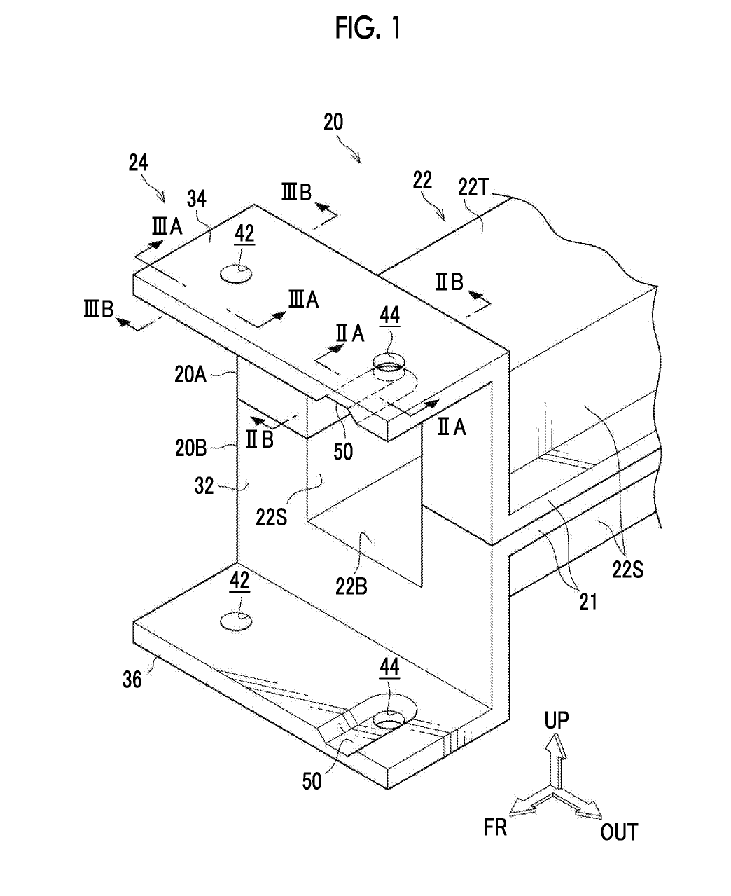

Each crush box 20 includes a main body part 22 that absorbs collision energy by being crushed by receiving a load in an axial direction, a front coupling part 24 serving as a “coupling part” for coupling the crush box 20 and the bumper RF 12 together, and a rear coupling part 26 for coupling the crush box 20 and each front side member 14 together, as principal parts. In addition, as illustrated in FIG. 1, the crush box 20 is formed by coupling an upper member 20A and a lower member 20B, which form a vertically symmetrical shape, together between mutual coupling flange parts 21.

As illustrated in FIG. 1, the main body part 22 has a closed sectional structure that forms a substantially rectangular tubular shape having the forward-rearward direction as the axial direction. Specifically, the main body part 22 is configured to include a top wall 22T, a bottom wall 22B, and right and left side walls 22S, and forms a substantially rectangular shape in a sectional view orthogonal to the axial direction. Upper parts of the top wall 22T and the right and left side walls 22S are formed at the upper member 20A, and lower parts of the bottom wall 22B and the right and left side walls 22S are formed at the lower member 20B.

As illustrated in FIG. 4, the rear coupling part 26 is formed in a plate shape that overhangs upward and downward, and rightward and leftward from a rear end of the main body part 22. The rear coupling part 26 is butted against a front flange 14F of the front side member 14 and is coupled to the front flange 14F by bolts, nuts, or the like (not illustrated). An upper part of the rear coupling part 26 is formed at the upper member 20A, and a lower part of the rear coupling part 26 is formed at the lower member 20B.

Next, the configuration of the front coupling part 24 will be described in detail with reference to FIG. 1.

The front coupling part 24 is configured to include a front wall 32 that overhangs upward and downward, and rightward and leftward from a front end of the main body part 22, an upper wall 34 that extends forward from an upper end of the front wall 32, and a lower wall 36 that extends forward from a lower end of the front wall 32.

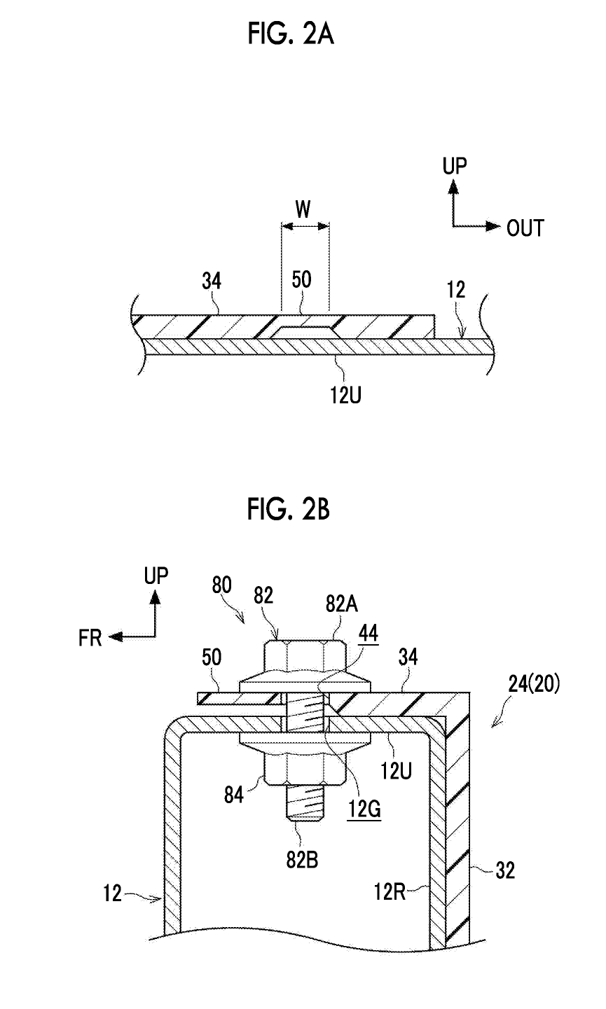

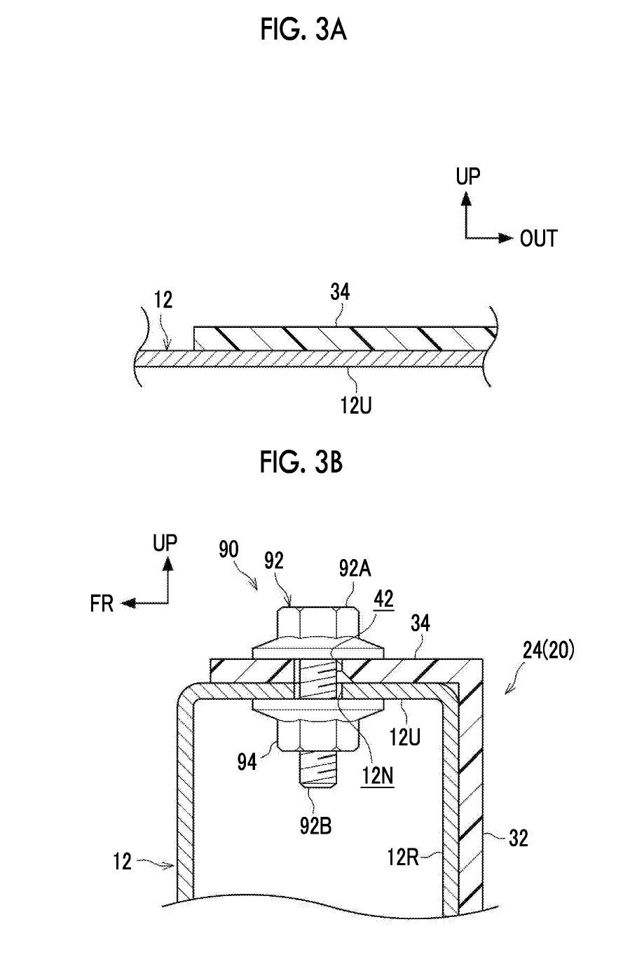

The front wall 32 is formed in a plate shape and a thickness direction thereof is directed to a substantially forward-rearward direction. As illustrated in FIG. 2B and FIG. 3B, the front wall 32 is butted against a rear wall 12R of the bumper RF 12. The coupling of the front wall 32 to the rear wall 12R of the bumper RF 12 may be performed or may not be performed.

The front wall 34 is formed in a plate shape and a thickness direction thereof is directed to a substantially upward-downward direction. An inner fastening hole 42 and an outer fastening hole 44 that pass through the upper wall 34 in the thickness direction are formed at the upper wall 34. A position where the inner fastening hole 42 is formed is inside a central axis of the main body part 22 in the vehicle width direction, and a position where the outer fastening hole 44 is formed is outside the central axis of the main body part 22 in the vehicle width direction.

As illustrated in FIG. 2A, FIG. 2B, FIGS. 3A and 3B, and the like, the upper wall 34 is superimposed on an upper wall 12U of the bumper RF 12 from above in a state where the crush box 20 and the bumper RF 12 are coupled together.

As illustrated in FIG. 2B and FIG. 3B, an inner fastening hole 12N and an outer fastening hole 12G respectively corresponding to the inner fastening hole 42 and the outer fastening hole 44 are formed at the upper wall 12U of the bumper RF 12. An inner nut 94 and an outer nut 84 are welded to a lower surface of the upper wall 12U of the bumper RF 12 at positions corresponding to the inner fastening hole 12N and the outer fastening hole 12G. The upper wall 34 is fastened to the upper wall 12U of the bumper RF 12 by an inner bolt 92 and an outer bolt 82 being threadedly engaged with each other from the upper wall 34 side of the front coupling part 24 of the crush box 20.

Accordingly, as illustrated in FIG. 3B, a peripheral portion of the inner fastening hole 42 in the upper wall 34 is fastened to the upper wall 12U of the bumper RF 12 with the inner bolt 92 and the inner nut 94 (hereinafter may be collectively referred to as an inner fastener 90). Hence, the peripheral portion of the inner fastening hole 42 in the upper wall 34 is an example of the “inner fastening part” of the present disclosure. Additionally, as illustrated in FIG. 2B, a peripheral portion of the outer fastening hole 44 in the upper wall 34 is fastened to the upper wall 12U of the bumper RF 12 with the outer bolt 82 and the outer nut 84 (hereinafter may be collectively referred to as an outer fastener 80). Hence, the peripheral portion of the outer fastening hole 44 in the upper wall 34 is an example of the “outer fastening part” of the present disclosure.

As illustrated in FIG. 1, FIG. 2B, and the like, a thin part 50 serving as a “weakened part”, which is made thinner than the other portions, is formed at a front part of the outer fastening hole 44 in the upper wall 34. In the thin part 50, a lower surface of the upper wall 34 is formed in a scooped shape, and an inclined step is formed between the thin part 50 and a portion other than the thin part 50 on the lower surface of the upper wall 34. Meanwhile, an upper surface of the upper wall 34 is so-called flush with the thin part 50 and the portion other than the thin part 50 without a step.

A range where the thin part 50 is formed is a range that extends toward the front from the position of the outer fastening hole 44, and a front end of the thin part 50 reaches a front end of the upper wall 34. Additionally, the width W of the thin part 50 (refer to the FIG. 2A, the dimension of the thin part 50 in a direction perpendicular to the direction in which the thin part 50 extends) is made substantially equal to the diameter of a shaft part 82B of the outer bolt 82.

Although the lower wall 36 has a vertically symmetrical shape with the upper wall 34 described above, the lower wall will be described below for confirmation.

The lower wall 36 is formed in a plate shape and a thickness direction thereof is directed to a substantially upward-downward direction. An inner fastening hole 42 and an outer fastening hole 44 that pass through the lower wall 36 in the thickness direction are formed at the lower wall 36. A position where the inner fastening hole 42 is formed is inside the central axis of the main body part 22 in the vehicle width direction, and a position where the outer fastening hole 44 is formed is outside the central axis of the main body part 22 in the vehicle width direction.

Although not illustrated, the lower wall 36 is superimposed on a lower wall 12L of the bumper RF 12 from below in a state where the crush box 20 and the bumper RF 12 are coupled together.

Additionally, although not illustrated, an inner fastening hole 12N and an outer fastening hole 12G respectively corresponding to the inner fastening hole 42 and the outer fastening hole 44 are formed at the lower wall 12L of the bumper RF 12. An inner nut 94 and an outer nut 84 are welded to an upper surface of the lower wall 12L of the bumper RF 12 at positions corresponding to the inner fastening hole 12N and the outer fastening hole 12G. The lower wall 36 is fastened to the lower wall 12L of the bumper RF 12 by an inner bolt 92 and an outer bolt 82 being threadedly engaged with each other from the lower wall 36 side of the front coupling part 24 of the crush box 20.

Accordingly, a peripheral portion of the inner fastening hole 42 in the lower wall 36 is fastened to the lower wall 12L of the bumper RF 12 by the inner fastener 90. Hence, the peripheral portion of the inner fastening hole 42 in the lower wall 36 is an example of the “inner fastening part” of the present disclosure. Additionally, a peripheral portion of the outer fastening hole 44 in the lower wall 36 is fastened to the lower wall 12L of the bumper RF 12 by the outer fastener 80. Hence, the peripheral portion of the outer fastening hole 44 in the lower wall 36 is an example of the “outer fastening part” of the present disclosure.

As illustrated in FIG. 1, a thin part 50 serving as a “weakened part”, which is made thinner than the other portions, is formed at a front part of the outer fastening hole 44 in the lower wall 36. In the thin part 50, an upper surface of the lower wall 36 is formed in a scooped shape, and an inclined step is formed between the thin part 50 and a portion other than the thin part 50 on the upper surface of the lower wall 36. Meanwhile, a lower surface of the lower wall 36 is so-called flush with the thin part 50 and the portion other than the thin part 50 without a step.

A range where the thin part 50 is formed is a range that extends toward the front from the position of the outer fastening hole 44, and a front end of the thin part 50 reaches a front end of the lower wall 36. Additionally, the width of the thin part 50 is made substantially equal to the diameter of the shaft part 82B of the outer bolt 82.

Working

Next, the working of the energy absorption structure S of the present embodiment will be described.

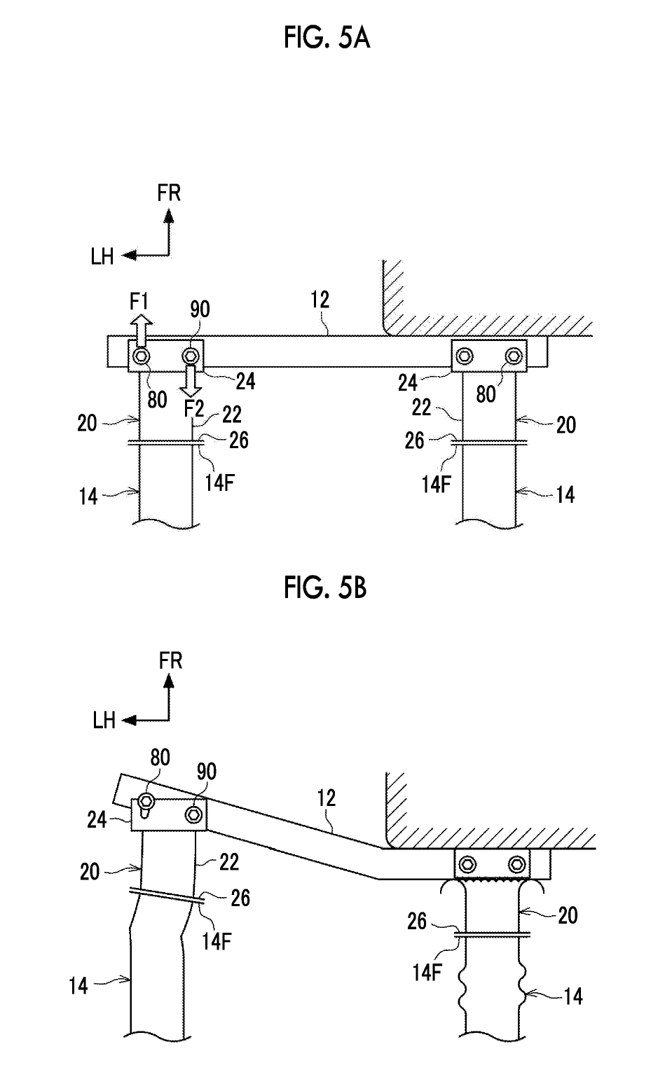

As illustrated in FIG. 4 and FIG. 5A, in the energy absorption structure S of the present embodiment, the crush boxes 20 made of the fiber reinforced resin are coupled to the bumper RF 12 that is provided at the front end part of the vehicle and extends in the vehicle width direction. Positions where the crush boxes 20 are coupled are positions shifted outward in the vehicle width direction with respect to the center in the vehicle width direction. Each crush box 20 is configured to include the main body part 22 disposed behind the bumper RF 12 in the vehicle, and the front coupling part 24 for coupling the crush box 20 and the bumper RF 12 together.

As illustrated in FIG. 1, the front coupling part 24 is configured to include the upper wall 34 and the lower wall 36, and the inner fastening hole 42 and the outer fastening hole 44 are formed in each of the upper wall 34 and the lower wall 36. As illustrated in FIG. 3B, the peripheral portion (“inner fastening part”) of the inner fastening hole 42 in the upper wall 34 is fastened to the upper wall 12U of the bumper RF 12 by the inner fastener 90. Additionally, although not illustrated, the peripheral portion (“inner fastening part”) of the inner fastening hole 42 in the lower wall 36 is fastened to the lower wall 12L of the bumper RF 12 by the inner fastener 90. Meanwhile, as illustrated in FIG. 2B, the peripheral portion (“outer fastening part”) of the outer fastening hole 44 in the upper wall 34 is fastened to the upper wall 12U of the bumper RF 12 by the outer fastener 80. Additionally, although not illustrated, the peripheral portion (“outer fastening part”) of the outer fastening hole 44 in the lower wall 36 is fastened to the lower wall 12L of the bumper RF 12 by the outer fastener 80.

For this reason, as illustrated in FIGS. 5A and 5B, a collision-side portion (the right side in the vehicle width direction) of the bumper RF 12 is displaced to the rear side of the vehicle during an offset collision. Meanwhile, when a portion opposite to the collision-side portion (the left side in the vehicle width direction) of the bumper RF 12 tries to be tilted in a plan view of the vehicle, a load (refer to arrow F2) to the rear side of the vehicle is applied to the inner fastener 90 that fastens the crush box 20 coupled to the portion opposite to the collision-side portion and a load (refer to arrow F1) to the front side of the vehicle is applied to the outer fastener 80.

Here, as illustrated in FIG. 1 and the like, in the energy absorption structure S of the present embodiment, the front part of the outer fastening hole 44 in each of the upper wall 34 and the lower wall 36 is provided with the thin part 50 that has a structure different from the peripheral portion of the inner fastening hole 42 in each of the upper wall 34 and the lower wall 36, specifically, the thin part 50 formed to be thinner than the peripheral portion of the inner fastening hole 42 in each of the upper wall 34 and the lower wall 36. Since the thin part 50 is formed to be thin, the thin part is more easily crushed when the load (refer to arrow F1) to the front side of the vehicle is applied to the outer fastener 80.

To describe in more detail, as illustrated in FIG. 2B, the thin part 50 is located in front of the shaft part 82B of the outer bolt 82. Thus, when the load to the front side of the vehicle is applied to the outer fastener 80, the thin part 50 of each of the upper wall 34 and the lower wall 36 is more easily crushed by the shaft part 82B of the outer bolt 82. In other words, compared to a structure where a portion provided with the thin part 50 in each of the upper wall 34 and the lower wall 36 is the same as the peripheral portion of the inner fastening hole 42, i.e., a structure where the thin part 50 is not provided, in the energy absorption structure S of the present embodiment, the thin part 50 of each of the upper wall 34 and the lower wall 36 is easily crushed when the load to the front side of the vehicle is applied to the outer fastener 80. When the thin part 50 of each of the upper wall 34 and the lower wall 36 is crushed, as illustrated in FIG. 5B, the fastening performed by the outer fastener 80 is released, and a bending moment acting on the main body part 22 of the crush box 20 is further suppressed. Also, breakage of the main body part 22 of the crush box 20 due to the bending moment is further suppressed. As a result, a load is more easily transmitted to the front side member 14 via the crush box 20.

In addition, FIG. 5B illustrates, as an example of target vehicle body deformation according to the energy absorption structure S of the present embodiment, an aspect in which, as breakage of the main body part 22 of the crush box 20 on a side opposite to the collision side is avoided, a load is transmitted to the front side member 14 via the crush box 20 on the side opposite to the collision side and the front side member 14 on the side opposite to the collision side is deformed to be folded inward in the vehicle width direction.

Additionally, the energy absorption structure S of the present embodiment has a configuration in which, since a shaft part 92B of the inner bolt 92 constituting the inner fastener 90 passes through each of the upper wall 34 and the lower wall 36 of the front coupling part 24 of a crush box 20 and the shaft part 92B has its axial direction directed to a substantially upward-downward direction of the vehicle, the bumper RF 12 can rotate about the shaft part 92B of the inner bolt 92 with respect to the crush box 20. Hence, as illustrated in FIG. 5B, even when a portion opposite to the collision-side portion of the bumper RF 12 is tilted in the plan view during an offset collision, the fastening performed by the inner fastener 90 is more easily maintained. As a result, a load from the bumper RF 12 is more easily transmitted to the front side member 14 via the crush box 20.

### Modification Example 1

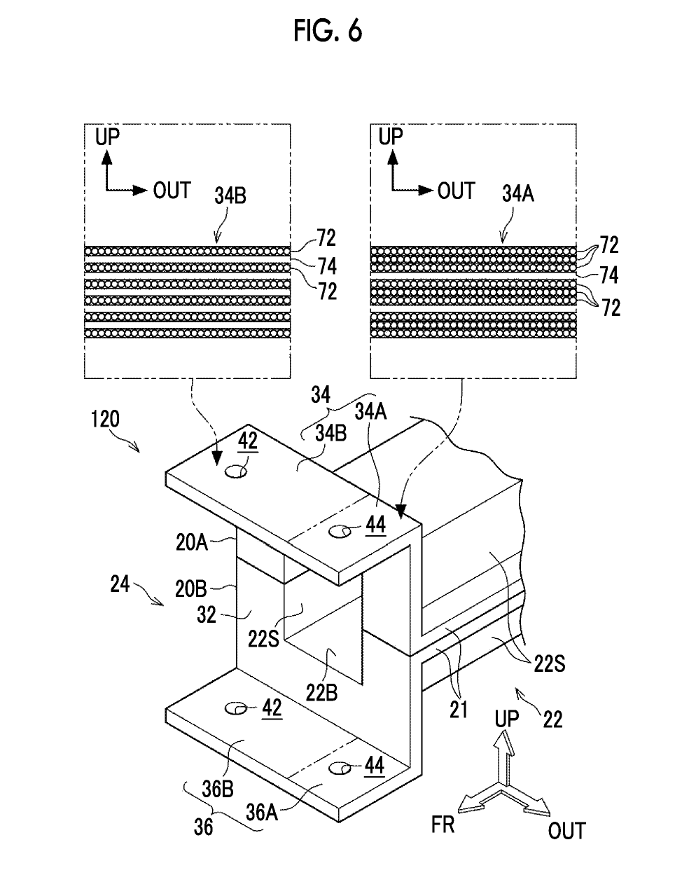

Next, Modification Example 1 of the energy absorption structure S of the present embodiment will be described with reference to FIG. 6.

In Modification Example 1, a specific structure of the “weakened part” is different from that of the above embodiment. Points different from the above embodiment will mainly be described, and points that coincide with those of the above embodiment will be designated by the same reference signs in the drawing and the description thereof will be omitted.

As illustrated in FIG. 6, the thin part 50 (refer to FIG. 1) is not formed in each of the upper wall 34 and the lower wall 36 of the front coupling part 24 of the crush box 120 related to Modification Example 1. Hence, the front part of the outer fastening hole 44 in each of the upper wall 34 and the lower wall 36 has a plate thickness approximately equal to the peripheral portion of the inner fastening hole 42.

The upper wall 34 of the modification example is configured to include a specific orientation part 34A and a general orientation part 34B that are different from each other in terms of the ratio of fiber orientation. The specific orientation part 34A is formed at the peripheral portion of the outer fastening hole 44 through which the outer fastener 80 is inserted, and a portion other than specific orientation part 34A is the general orientation part 34B.

In the general orientation part 34B, a forward-rearward orientation layer 72 having the orientation direction of carbon fiber as the forward-rearward direction of the vehicle, and an orthogonal orientation layer 74 having the orientation direction of carbon fiber as the vehicle width direction are alternately laminated, and the orientation in the forward-rearward direction of the vehicle and the orientation in the vehicle width direction are equally distributed as a whole. Meanwhile, in the specific orientation part 34A, a forward-rearward orientation layer 72 is laminated more than the orthogonal orientation layer 74, and the forward-rearward direction of the vehicle is distributed as a main orientation direction as a whole.

Additionally, the lower wall 36 of the modification example also has the same configuration as the above-described upper wall 34, that is, a vertically symmetrical structure. Specifically, the lower wall 36 is configured to include a specific orientation part 36A in which the forward-rearward direction of the vehicle is distributed as a main orientation direction and a general orientation part 36B in which the orientation in the forward-rearward direction of the vehicle and the orientation in the vehicle width direction are equally distributed. The inner fastening hole 42 is formed in the general orientation part 36B, and the outer fastening hole 44 is formed in the specific orientation part 36A.

Working

Next, the working of Modification Example 1 will be described.

In Modification Example 1, the inner fastening hole 42 is formed in each of the general orientation parts 34B, 36B of the upper wall 34 and the lower wall 36, and the outer fastening hole 44 is formed in each of the specific orientation parts 34A, 36A of the upper wall 34 and the lower wall 36. For that reason, the peripheral portion of the inner fastening hole 42 in each of the upper wall 34 and the lower wall 36 has a structure in which the fiber orientation direction is distributed to be equal in terms of the orientations in the forward-rearward direction and the vehicle width direction of the vehicle. In contrast, the peripheral portion of the outer fastening hole 44 in each of the upper wall 34 and the lower wall 36 has a structure different from the peripheral portion of the inner fastening hole 42, that is, a structure in which the direction of fiber orientation is distributed with the forward-rearward direction of the vehicle as a main direction.

Hence, the front part of the outer fastening hole 44 has a structure (specific orientation parts 34A, 36A) in which the direction of fiber orientation is distributed with the forward-rearward direction of the vehicle as a main direction. For this reason, as compared to a case where the front part of the outer fastening hole 44 serves as the general orientation part 34B, each of the upper wall 34 and the lower wall 36 is easily crushed by the shaft part 82B of the outer bolt 82 when the load to the front side of the vehicle is applied to the outer fastener 80. For this reason, also in Modification Example 1, as in the embodiment, the time of offset collision, a bending moment acting on the main body part 22 of the crush box 120 on the side opposite to the collision side is further suppressed, and breaking of the main body part 22 of the crush box 120 due to the bending moment is further suppressed.

### Modification Example 2

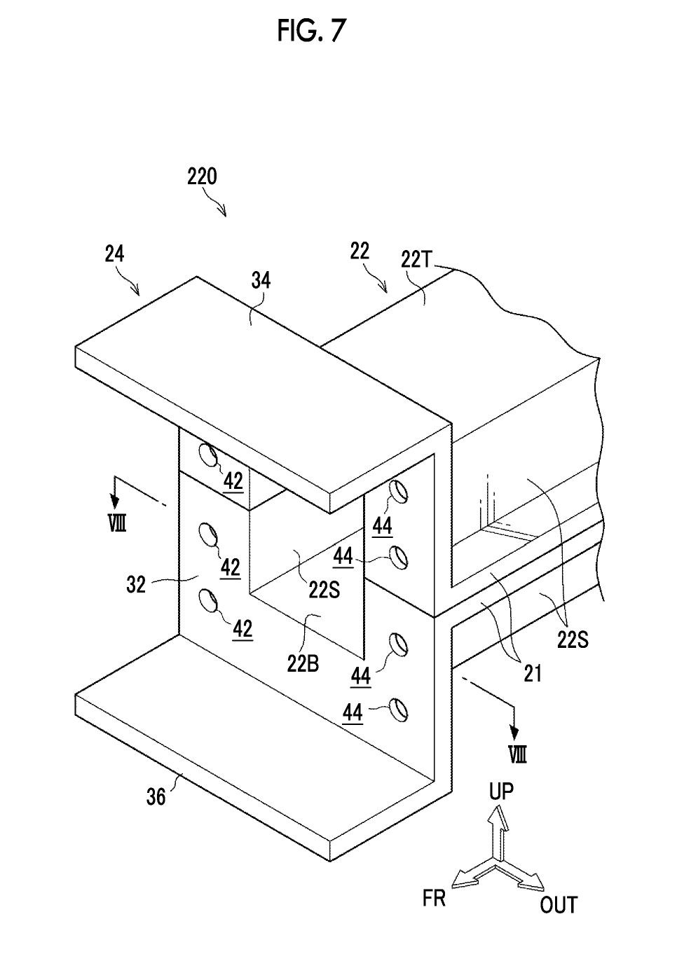

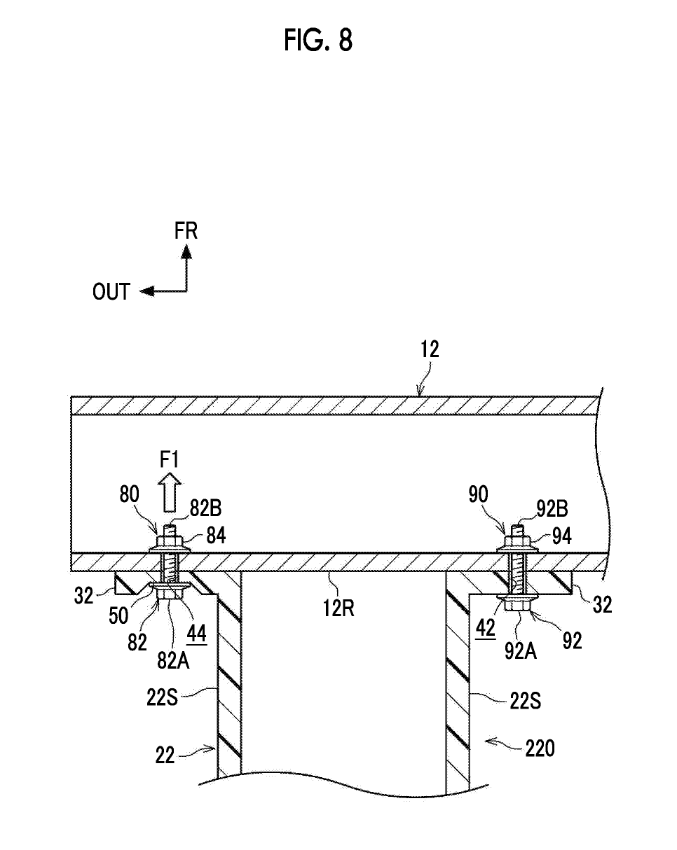

Next, Modification Example 2 of the energy absorption structure S of the embodiment will be described with reference to FIGS. 7 and 8.

As illustrated in FIG. 7, in a crush box 220 of Modification Example 2, a fastening hole for fastening is not formed in each of the upper wall 34 and the lower wall 36 of the front coupling part 24, and the upper wall 34 and the lower wall 36 are coupled to the bumper RF 12 with an adhesive. Meanwhile, the inner fastening hole 42 and the outer fastening hole 44 are formed in the front wall 32 of the front coupling part 24.

The inner fastening hole 42 is formed in a portion inside the front end of the main body part 22 in the vehicle width direction, and four inner fastening holes 42 are formed side by side in the upward-downward direction. The outer fastening hole 44 is formed in a portion outside the front end of the main body part 22 in the vehicle width direction, and four outer fastening holes 44 are formed side by side in the upward-downward direction.

FIG. 8 is a sectional view taken along line VIII-VIII in FIG. 7. As illustrated in FIG. 8, a thin part 50 serving as a “weakened part”, which is made thinner than the other portions, is provided at a peripheral portion of each outer fastening hole 44 in the front wall 32. The thin part 50 is provided corresponding to each of the four outer fastening holes 44. Accordingly, a head part 82A of the outer bolt 82 comes into contact with the thin part 50 in the front wall 32. Meanwhile, no thin part is provided in the peripheral portion of each of the four inner fastening holes 42 in the front wall 32.

Working

Next, the working of Modification Example 2 will be described.

In Modification Example 2, no thin part is provided at the peripheral portion of each inner fastening hole 42 in the front wall 32, and a structure different from the peripheral portion of the inner fastening hole 42, that is, the thin part 50, which is made thinner than the peripheral portion of the inner fastening hole 42, is provided at the peripheral portion of each outer fastening hole 44 in the front wall 32. Hence, in a case where the load (refer to arrow F1 of FIG. 8) to the front side of the vehicle is applied to the outer fastener 80 during an offset collision, the thin part 50 of the head part 82A located on the front side of the vehicle is easily crushed by the head part 82A of the outer bolt 82. For this reason, also in Modification Example 2, as in the embodiment, the time of offset collision, a bending moment acting on the main body part 22 of the crush box 220 is further suppressed, and breaking of the main body part 22 due to the bending moment is further suppressed.

Supplementary Description

In addition, a method of providing the “weakened part” of the present disclosure is not limited to the embodiment and Modification Examples 1 and 2. For example, the “weakened part” may be provided by forming the front part of the outer fastening hole 44 in each of the upper wall 34 and the lower wall 36 to be thin and making the orientation ratio in the forward-rearward direction of the vehicle relatively large, or may be provided by a method completely different from the embodiment and Modification Examples 1 and 2.

Additionally, although an example in which the bolt and the nut are used as examples of the “inner fastener” and the “outer fastener” of the present disclosure has been described in the embodiment and Modification Examples 1 and 2, the present disclosure is not limited to this. For example, a rivet or a self-piercing rivet (SPR) is also included in the “inner fastener” and the “outer fastener” of the present disclosure.

Additionally, as illustrated in FIG. 1 and FIG. 2B, an example in which the range where the thin part 50 is formed is the range that extends toward the front from the position of the outer fastening hole 44 and the front end of the thin part 50 reaches the front end of each of the upper wall 34 and the lower wall 36 has been described in the embodiment. However, the front end of the thin part 50 may not reach the front end of each of the upper wall 34 and the lower wall 36. Additionally, the range where the thin part 50 is formed is not the range (linear range) that extends toward the front from the outer fastening hole 44, and may be a circular-arc range that passes through the position of the outer fastening hole 44 and has the inner fastening hole 42 as the center.

Additionally, although an example in which the crush box 20 is made of carbon fiber reinforced resin has been described in the embodiment, the present disclosure is not limited to this. The crush box 20 may be made of fiber reinforced resin, for example, may be made of glass fiber reinforced resin.

Additionally, although an example in which the energy absorption structure is applied to a vehicle front structure has been described in the embodiment, the energy absorption structure of the aspect of the present disclosure may be applied to a vehicle rear structure.

What is claimed is:

1. An energy absorption structure comprising:
a bumper reinforcement that is provided at a front end part or a rear end part of a vehicle and extends in a vehicle width direction of the vehicle; and
a crush box that is coupled to the bumper reinforcement and is made of fiber reinforced resin, wherein
the crush box is coupled to the bumper reinforcement at a position shifted outward in the vehicle width direction with respect to a center in the vehicle width direction of the vehicle,
the crush box includes a main body part and a coupling part,
the main body part is a portion that is disposed at a position closer to a center in a forward-rearward direction of the vehicle than the bumper reinforcement in the forward-rearward direction of the vehicle,
the coupling part is a portion that couples the crush box and the bumper reinforcement together,
the coupling part includes an inner fastening part and an outer fastening part,
the inner fastening part is fastened to the bumper reinforcement by an inner fastener,
the outer fastening part is fastened to the bumper reinforcement by an outer fastener at a position behind a position where the inner fastening part is fastened to the bumper reinforcement outward from the center in the vehicle width direction of the vehicle, and
the outer fastening part includes a weakened part having a structure different from the inner fastening part such that the outer fastening part is easily crushed as compared to the inner fastening part when a load toward a side far from the center in the forward-rearward direction of the vehicle acts on the outer fastener.

2. The energy absorption structure according to claim 1, wherein the inner fastener includes a shaft part that passes through the inner fastening part and has an axial direction directed to an upward-downward direction of the vehicle.

3. The energy absorption structure according to claim 1, wherein the weakened part is a portion that is formed to be thinner than the inner fastening part.

4. The energy absorption structure according to claim 1, wherein the weakened part is a portion having a fiber orientation ratio different from the inner fastening part.
